(19) United States
(12) Patent Application Publication
(10) Pub. No.: US 2015/0217589 A1
(43) Pub. Date: Aug. 6, 2015

(54) Book

(71) Applicants: Yuchen Zhang, Tangshan (CN); Xiaochuan Zhang, Tangshan (CN)

(72) Inventors: Yuchen Zhang, Tangshan (CN); Xiaochuan Zhang, Tangshan (CN)

(21) Appl. No.: 14/369,774

(22) PCT Filed: Dec. 27, 2012
(86) PCT No.: PCT/CN2012/001744

§ 371 Date: Nov. 11, 2014

(30) Foreign Application Priority Data
Dec. 31, 2011 (CN) 201110455454.4
Dec. 31, 2011 (CN) 201120569152.5

(51) Int. Cl. B42D 1/00

(52) U.S. Cl. CPC B42D 1/009

(57) ABSTRACT

A book comprises a front cover, a back cover, a spine (1), and sheets with page numbers, a text arrangement structure, etc. thereon, wherein the vertical direction of the text on both sides of each sheet in the main body of the book is roughly perpendicular to the spine (1), the vertical direction of the text from the lower edge thereof to the upper edge thereof are referred to as the text's upright direction, and the vertical upright direction of the text in the main body is directed to the fore edge (2), which is approximately parallel to the spine (1), so that in a layout version of horizontal setting for the book, each line of the text in the main body on each sheet is approximately parallel to the spine (1) and in a layout version of vertical setting for the book, each line of the text in the main body on each sheet is approximately vertical to the spine (1). When a reader reads the book while lying down on one side, the reader can simply adjust the orientation of the book so that the verso and recto change places in an equivalent manner, thus making it more comfortable for the reader to read the book.

### FIELD OF THE INVENTION

The present of the invention relates to a book.

### BACKGROUND OF THE INVENTION

A traditional book generally comprises a front cover, a back cover, a spine, sheets with page numbers, a text arrangement structure, etc., so that when a reader opens the book to read, the book shows verso and recto to the spine as a dividing line to the reader, which constitute interrelated elements, wherein: the vertical direction of the text on both sides of each sheet in the main body of the book is approximately parallel to the spine.

In the traditional horizontal layout of a book, the lines of the texts in the main body on each sheet are approximately perpendicular to the spine; and in a traditional vertical layout of a book, the lines of the texts in the main body on each sheet are approximately parallel to the spine. This book structure is suitable for readers to read while sitting down. But this traditional book structure has a downside when people read in bed. Most adults have a habit of reading in bed, and bedridden people can only read in bed. Generally, when reading in bed, people usually lie on one side, open a book at an angle of around 90°, use one side of the sheets of the book and the spine as a support. Generally, when reading in a right side-lying position, the recto and the spine are often used as a support, so that the book itself plays a role of a book support, while reading the verso to form a good reading angle and a comfortable reading position. But when the recto is next to read, the reading angle has to be changed greatly, and the book must be lifted at this time, the book itself no longer plays a role as a book support, which is very inconvenient. To continue to maintain a comfortable reading position and a good reading angle, the reader needs to rotate her body in a 180° angle, and read at a left side-lying position. In this way, a reader must rotate her body every time she needs to read the next page. This is obviously inconvenient.

In short, when reading while lying down on one side, the verso and recto cannot change places in an equivalent manner, with pages turning over, the reading angles and relative positions need to change frequently to the reader, and the reader must frequently adjust her reading position to adapt to this change. Adjusting the position of reading is not desirable, and readers do not know what to do, cannot easily adapt, feel uncoordinated and tired.

### SUMMARY OF THE INVENTION

The object of the present invention is to modify the traditional book structure so that when people read book at a side-lying position, they only need to rotate the book, without rotating their bodies. The verso and recto change places in an equivalent manner, making the adjustment of a reading position depend entirely on a reader's own will, and not on the process of turning pages, and both of the process of turning pages and changing the reader's reading position achieve perfect coordination, therefore solving the above-discussed problems in the prior art.

The technical solution of the present invention is: a book, a cover, a spine, sheets with page numbers, a text arrangement structure, and etc. thereon, wherein the vertical direction of the text on both sides of each sheet of the main body of the book (the term “text” can be any language in the world, letters, characters, graphics, pictures, etc.) is roughly perpendicular to the spine, the vertical direction of the text from the lower edge thereof to the upper edge thereof is referred to as the text's upright direction, and the vertical upright direction of the text in the main body is all directed to the fore edges which are approximately parallel to the spine. In a layout version of horizontal setting of a book, the line (or direction) of the text in the main body on each sheet is approximately parallel to the spine; and in a layout version of vertical setting of the book, the line of the text in the main body on each sheet is approximately perpendicular to the spine. The book's cover or cover page (usually the first page that is immediately next to the front cover) indicates appropriate reading positions, features, and advantages of the book; the design of a front cover, a back cover, a spine, table of contents and others is preferably coordinated with layout structure and forms of page numbers inside the book, etc.

The above structural characteristics of a book in accordance with the present invention enable reading at a side-lying position very comfortable.

For example, when reading at a side-lying position, opening a book at an angle of about 90°, reading the verso is very comfortable, at this time the recto of the book and spine may be used as a support, with the book itself playing a role of a book support. When a reader begins to read the next page after reading the verso, the reader does not need to turn over her body and change position. Rather, the reader needs only to rotate horizontally the book by about 180°, then use the spine as an axis, rotate the book 90° toward the direction of reader so that the recto converts into the verso, the view effect relative to the reader is the same, and the book itself still plays a role of a book support. Similarly, when reading at a left side-lying position, reading recto is very comfortable, at this time the verso and the spine may be used as a support, the book itself plays a role of book support. When a reader reads the next page after reading the verso, the reader does not have to rotate her body and change positions. Rather, the reader needs only to rotate horizontally the book about 180°, then use the spine as an axis, rotate the book 90° toward the direction of the reader, the verso converts into the recto, with the view effect relative to the reader remaining the same, and the book itself still plays a role of a book support. During the reading process, the reader does not need to change her positions of reading, the book itself always plays a role of a book support and the viewing effect of the reader remains the same, whether the verso or recto is read.

Reading a book in accordance with the present invention in other positions is also a good choice. For example, when sitting before a desk to read, a reader can open the book at more than 90° toward the reader, a side of sheets (opposite to the sheet being read) and the spine may be used as a support, the book is very stable, the sheet is very flat, which is like watching an opened laptop computer screen, the reader feels very comfortable.

The beneficial effects of the present invention are: since the vertical upright direction of the text on both sides of each sheet in the main body of the book is roughly perpendicular to the spine, and the vertical upright direction of the text in the main body is directed to the fore edges which are approximately paralleled to the spine, when a reader is reading the book in a side-lying position, the reader can just gently turn the books, without turning the reader's body, with the verso and recto changing places in an equivalent manner. In this process, the reader can maintain a good reading view from the beginning to the end, the book itself has always played a role of a book support. Therefore, the reader can change her reading position at her will and not affected by turning pages, making both page turning and reader's reading position achieve perfect coordination, and making the reader feel more comfortable when reading in a side-lying position. A book in accordance with the present invention is more suitable to bedridden people who often have to read books in a side-lying position so that they can be freed from dependence on a book support, therefore eliminating the hassle and costs of a buying and using a book support.

### BRIEF DESCRIPTION OF THE DRAWINGS

FIG. 1 is a structure view to show a layout version of horizontal setting of a book in accordance with an embodiment of the present invention.

FIG. 2 is the outer appearance view of the layout version of the horizontal setting of a book in accordance with an embodiment of the present invention.

FIG. 3 is a structure view to show the layout version of vertical setting of a book in accordance with an embodiment of the present invention. (Note that in FIG. 3, the original Asia Characters are arranged vertically and flows from the right to the left page)

In the above figures, 1-spine, 2-fore edges.

### DETAILED DESCRIPTION OF PREFERRED EMBODIMENTS

The following description of preferred embodiments is to further illustrate, but not to limit the present invention.

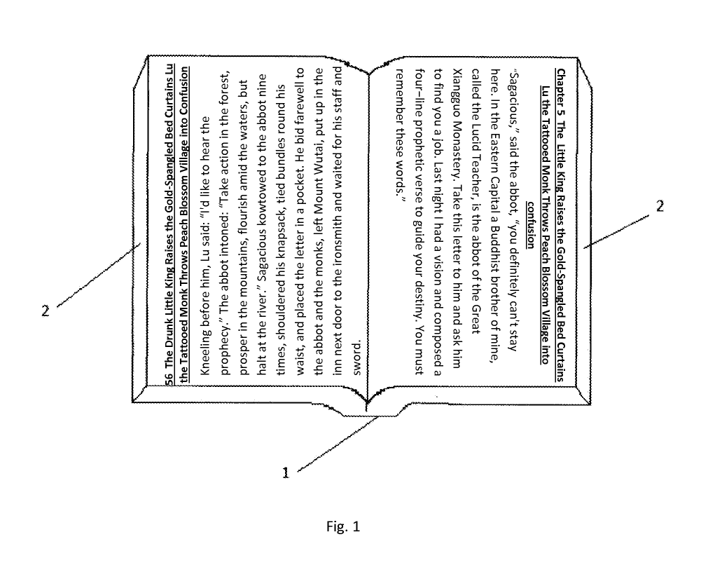

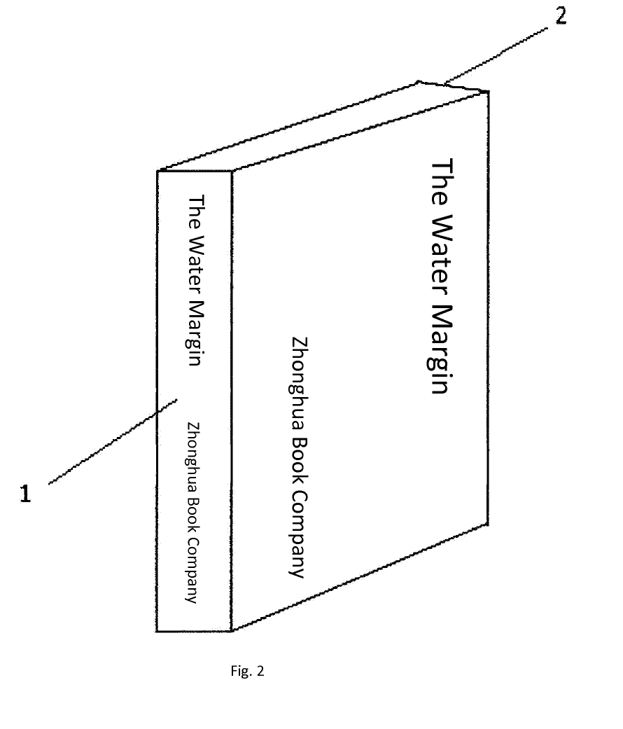

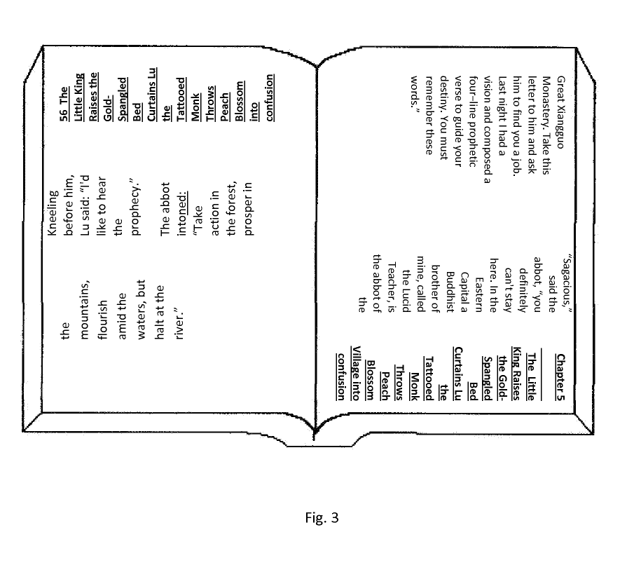

FIGS. 1, 2 and 3 show a book with the content of a classical Chinese fiction “The Water Margin”, including covers, a spine, sheets with page numbers, and a text arrangement structure, etc. thereon. The vertical direction of the text on both sides of each sheet in the main body of the book is roughly perpendicular to the spine, the vertical direction of the text from the lower edge thereof to the upper edge thereof is referred to as the text's upright direction, and then the vertical upright direction of the text in the main body is directed to the fore edges which are approximately parallel to the spine. In a layout version of horizontal setting of the book, the lines of the text in the main body on each sheet are approximately parallel to the spine 1. In a layout version of vertical setting of the book, the lines of the texts in the main body on each sheet are approximately perpendicular to the spine 1. The title on the cover has a text orientation that is consistent with the text in the main body. The book cover or cover page inside indicates appropriate reading posture, features, and advantages.

1. (canceled)

2. A book comprising: a front cover, a back cover, a spine, sheets with page numbers, a text on the sheets, and fore edges which are approximately parallel to the spine, wherein the sheets are connected with the spine, the vertical direction of the text on both sides of each sheet in the main body of the book is roughly perpendicular to the spine, the vertical direction of the text from the lower edge thereof to the upper edge thereof is referred to as the text's upright direction, and the vertical upright direction of the text in the main body is directed to the fore edges, in a layout version of horizontal setting of the book, the lines of the text on each sheet in the main body are approximately parallel to the spine, and in a layout version of vertical setting of the book, the lines of the text on each sheet in the main body are approximately vertical to the spine.

3. The book of claim 2 wherein the front cover, the back cover, and the spine are coordinated with the layout of the book and format of the page numbers of the text.

4. The book of claim 2 wherein the front cover and back cover have a text orientation that is consistent with the text in the main body of the book.

5. The book of claim 1 wherein the front cover or a cover page that is immediately next to the front cover provides information indicating appropriate reading posture, features, and advantages of the book.
